(19) United States
(12) Patent Application Publication
(10) Pub. No.: US 2016/0281873 A1
(43) Pub. Date: Sep. 29, 2016

(54) PRESSURE-REDUCING APPARATUS

(71) Applicant: AISAN KOGYO KABUSHIKI KAISHA, Obu-shi (JP)

(72) Inventor: Mamoru YOSHIOKA, Nagoya-shi (JP)

(73) Assignee: AISAN KOGYO KABUSHIKI KAISHA, Obu-shi (JP)

(21) Appl. No.: 15/065,188

(22) Filed: Mar. 9, 2016

(30) Foreign Application Priority Data
Mar. 26, 2015 (JP) 2015-063751

(51) Int. Cl. F16K 17/168

(52) U.S. Cl. CPC F16K 17/168

(57) ABSTRACT

A pressure-reducing apparatus is configured to reduce and regulate a primary-side gas pressure through two pressure-reducing valves arranged in series to generate a secondary-side gas pressure. In an intermediate passage, the gas after being pressure-reduced by the first pressure-reducing valve but before being pressure-reduced by the second pressure-reducing valve. The communication passage allows communication between the intermediate passage and a second pressure-regulating chamber of the second pressure-reducing valve. A check valve and configured to open when the gas pressure in the intermediate passage becomes higher than a predetermined valve opening pressure, thereby allowing the gas to flow from the intermediate passage toward the second pressure-regulating chamber through the communication passage, and block a flow of gas in an opposite direction. The communication passage has at least part having a passage cross-sectional area set smaller than a passage cross-sectional area of the intermediate passage.

### CROSS-REFERENCE TO RELATED APPLICATIONS

This application is based upon and claims the benefit of priority from the prior Japanese Patent Application No. 2015-063751 filed on Mar. 26, 2015, the entire contents of which are incorporated herein by reference.

### BACKGROUND OF THE INVENTION

1. Field of the Invention

The present invention relates to a pressure-reducing apparatus provided with two pressure-reducing valves arranged in series, and configured to reduce and regulate primary-side pressure of fluid in two stages by use of the two pressure-reducing valves to generate secondary-side pressure of the fluid.

2. Related Art

Heretofore, the technique of the above-mentioned type is known as a pressure control apparatus for gas fuel disclosed for example in Japanese unexamined patent application publication No. 2013-204441 (JP-A-2013-204441). This apparatus is used in a gas fuel supply system to control a flow of gas fuel stored in a fuel tank and supply the gas fuel to an engine through an injector. Specifically, this apparatus is provided with a fuel passage to supply gas fuel from the fuel tank to the injector. In this fuel passage, two pressure-reducing valves are arranged in series to regulate the pressure of the gas fuel in two stages. The gas fuel in the fuel tank is thus supplied to the injector after having subjected to two-stage pressure reduction and regulation through the two pressure-reducing valves.

The above-mentioned apparatus includes a first pressure-reducing valve to reduce the pressure of the gas fuel in the fuel tank to a predetermined first pressure, a second pressure-reducing valve to reduce the reduced gas fuel pressure to a predetermined second pressure (lower than the first pressure) with which the injector can inject the gas fuel, an electromagnetic drive unit to change a value of the second pressure related to the second pressure-reducing valve, an intermediate passage in which the gas fuel flows after being pressure-reduced by the first pressure-reducing valve but before being pressure-reduced by the second pressure-reducing valve, and a relief valve provided in the intermediate passage. The two pressure-reducing valves arranged in series upstream of the injector can effectively reduce the pressure of gas fuel to be supplied to the injector. The injector can therefore have high design flexibility of a mechanical structure.

### SUMMARY OF INVENTION

### Problem to be Solved by the Invention

However, in the apparatus disclosed in JP-A-2013-204441, if foreign substances are trapped or caught by a valve element of the first pressure-reducing valve and thus the valve element gets stuck as remaining open (valve opening failure) or the valve element delays in closing (valve closing delay), the pressure of gas fuel in the intermediate passage sharply rises. In this case, when the pressure at a set value or higher acts on the relief valve, this relief valve is caused to open and thus excessive load is applied to a passage downstream of the relief valve. Accordingly, excessive pressure load is applied to a downstream side from the second pressure-reducing valve, the gas fuel in a passage on the downstream side may leak out. To prevent this leakage of gas fuel, it is necessary to provide a structure for enhancing pressure resistance of the passage downstream of the second pressure-reducing valve. This leads to a cost increase of the apparatus by just that additional structure.

The present invention has been made in view of the circumstances to solve the above problems and has a purpose to provide a pressure-reducing apparatus capable of preventing excessive pressure load from being applied to a downstream side from a second pressure-reducing valve even when valve opening failure or valve closing delay occurs in a first pressure-reducing valve, and eliminating the need for any additional structure to ensure pressure resistance of the downstream side.

### Means of Solving the Problem

To achieve the above purpose, one aspect of the invention provides a pressure-reducing apparatus including two pressure-reducing valves arranged in series, the pressure-reducing apparatus being configured to reduce and regulate primary-side pressure of fluid in two stages by use of the two pressure-reducing valves to generate secondary-side pressure of the fluid, wherein the two pressure-reducing valves include a first pressure-reducing valve placed on an upstream side and a second pressure-reducing valve placed on a downstream side; the pressure-reducing apparatus further includes: an intermediate passage in which the fluid after being pressure-reduced by the first pressure-reducing valve but before being pressure-reduced by the second pressure-reducing valve; a communication passage allowing communication between the intermediate passage and a downstream part in the second pressure-reducing valve; and a check valve provided in the communication passage and configured to open when pressure of the fluid in the intermediate passage becomes higher than a predetermined valve opening pressure to allow the fluid to flow from the intermediate passage toward the downstream part in the second pressure-reducing valve through the communication passage, and configured to inhibit the fluid from flowing in an opposite direction, and the communication passage has at least a part having a passage cross-sectional area set smaller than a passage cross-sectional area of the intermediate passage.

### Effects of the Invention

According to the present invention, it is possible to prevent excessive pressure load from being applied to a downstream side from a second pressure-reducing valve even when valve opening failure or valve closing delay occurs in a first pressure-reducing valve, and thus to eliminate the need for any further structure to ensure pressure resistance of the downstream side.

### BRIEF DESCRIPTION OF THE DRAWING

FIG. 1 is a schematic configuration view of a fuel cell system in a first embodiment;

FIG. 2 is a sectional view of a high-pressure regulator in the first embodiment;

FIG. 3 is a schematic sectional view showing an intermediate passage, a communication passage, and a check valve in the high-pressure regulator in the first embodiment;

FIG. 4 is a time chart showing behaviors of (a) an opening degree of a main stop valve, (b) an opening degree of the check valve, (c) an opening degree of a first regulator, and (d) pressure in the intermediate passage and pressure in an outlet passage in the first embodiment;

FIG. 5 is a sectional view of a high-pressure regulator in a second embodiment;

FIG. 6 is a schematic sectional view showing an intermediate passage, a communication passage, and a check valve in the high-pressure regulator in the second embodiment;

FIG. 7 is a sectional view of a high-pressure regulator in a third embodiment;

FIG. 8 is a schematic sectional view showing an intermediate passage, a communication passage, and a check valve in the high-pressure regulator in the third embodiment; and

FIG. 9 is a schematic sectional view showing an intermediate passage, a communication passage, and a check valve in a fourth embodiment.

### DESCRIPTION OF EMBODIMENTS

### First Embodiment

A detailed description of a first embodiment of a pressure-reducing apparatus of the present invention applied to a fuel cell system will now be given referring to the accompanying drawings.

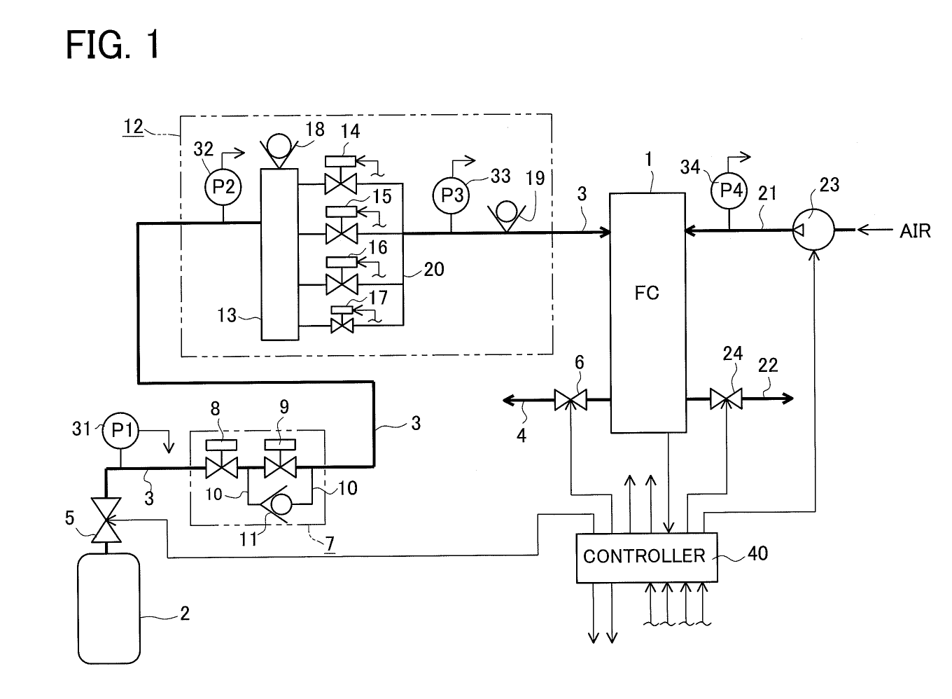

FIG. 1 is a schematic configuration view of the fuel cell system in the first embodiment. This fuel cell system will be mounted in an electric vehicle and used to supply electric power to a drive motor (not shown) of the vehicle. The fuel cell system is provided with a fuel cell (FC) 1 and a hydrogen cylinder 2. The fuel cell 1 is configured to generate electric power (electricity) upon receipt of hydrogen gas as fuel gas and air as oxidant gas. The electric power generated in the fuel cell 1 will be supplied to the drive motor through an inverter (not shown). The hydrogen cylinder 2 stores high-pressure hydrogen gas.

On an anode side of the fuel cell 1, a hydrogen supply system is provided. This hydrogen supply system includes a hydrogen supply passage 3 for supplying hydrogen gas from the hydrogen cylinder 2 to the fuel cell 1 which is a supply destination, and a hydrogen discharge passage 4 for discharging hydrogen delivered out of the fuel cell 1. In the hydrogen supply passage 3 immediately downstream of the hydrogen cylinder 2, there is provided a main stop valve 5 constituted of an electromagnetic valve for switching between supply and shutoff of hydrogen gas from the hydrogen cylinder 2 to the hydrogen supply passage 3. In the hydrogen discharge passage 4, a first changeover valve 6 constituted of an electromagnetic valve is provided.

In the hydrogen supply passage 3 downstream of the main stop valve 5, there is provided a high-pressure regulator 7 to reduce the pressure of the hydrogen gas. In the hydrogen supply passage 3 located between the main stop valve 5 and the high-pressure regulator 7, a primary pressure sensor 31 is provided to detect the pressure in this passage 3 as a primary pressure P1. This primary pressure P1 may be assigned a value in a range of 0.1 to 90 (MPa), for example.

The high-pressure regulator 7 corresponds to one example of the pressure-reducing apparatus of the invention. This high-pressure regulator 7 includes a first regulator 8 and a second regulator 9 arranged in series and is configured to reduce and regulate the pressure of hydrogen gas on a primary side (“primary-side pressure of hydrogen gas”) of the high-pressure regulator 7 in two stages to thereby generate the pressure of hydrogen gas on a secondary side (“secondary-side pressure of hydrogen gas”) of the high-pressure regulator 7. The high-pressure regulator 7 further includes, in addition to the first regulator 8 and second regulator 9, a communication passage 10 allowing communication between an upstream part and a downstream part of the second regulator 9, and a check valve 11 placed in the communication passage 10. These components are integrally configured as a single unit. In the high-pressure regulator 7, the first regulator 8 is located on an upstream side and the second regulator 9 is located on a downstream side. The first regulator 8 and the second regulator 9 respectively correspond to one example of a first pressure-reducing valve and a second pressure-reducing valve of the invention. In the high-pressure regulator 7, the pressure of the hydrogen gas reduced by the first regulator 8 is further reduced by the second regulator 9, that is, the pressure of the hydrogen gas is reduced in two stages.

In the hydrogen supply passage 3 downstream of the high-pressure regulator 7, there is provided a hydrogen flow regulating device 12 for regulating a flow rate of hydrogen gas to be supplied to the fuel cell 1. This hydrogen flow regulating device 12 includes a delivery pipe 13 and a plurality of injectors 14, 15, 16, and 17. The delivery pipe 13 is arranged to distribute the hydrogen gas from the hydrogen supply passage 3 to the plurality of injectors 14 to 17 and thus has a predetermined volume. With respect to this delivery pipe 13, the injectors 14 to 17 are connected in parallel. The delivery pipe 13 is provided with an intermediate-pressure relief valve 18 which will be opened when the pressure in the delivery pipe 13 exceeds a predetermined value (e.g., 3 (MPa)) to release the pressure. The injectors 14 to 17 includes the first injector 14, the second injector 15, and the third injector 16 each of which will inject the hydrogen gas with a normal flow rate and the fourth injector 17 which will inject the hydrogen gas with a smaller flow rate than the normal flow rate. Each of the injectors 14 to 17 is set with a valve opening pressure, corresponding to the pressure of hydrogen gas acting on respective upstream side, to enable valve opening of each of the injectors 14 to 17. In this embodiment, the valve opening pressures of the injectors 14 to 17 are individually set for example so that the valve opening pressure of the first to third injectors 14 to 16 is 3 (MPa) and the valve opening pressure of the fourth injector 17 is 10 (MPa). In the hydrogen supply passage 3 immediately upstream of the delivery pipe 13, a secondary pressure sensor 32 is provided to detect the pressure in the passage 3 as a secondary pressure P2. The secondary pressure P2 may be applied with a value in a range of 1.1 to 1.6 (MPa) for example.

A downstream side of each injector 14 to 17 is connected to the fuel cell 1 through the hydrogen supply passage 3. In the hydrogen supply passage 3 at a position immediately downstream of each injector 14 to 17, a tertiary pressure sensor 33 is provided to detect the internal pressure of the passage 3 at that position as a tertiary pressure P3. This tertiary pressure P3 may be applied with a value in a range of 0.1 to 0.3 (MPa) for example. In the hydrogen supply passage 3 downstream of the tertiary pressure sensor 33, there is provided a low-pressure relief valve 19 configured to open when the internal pressure of the passage 3 becomes a predetermined value or higher, thereby releasing that pressure.

In the present embodiment, the delivery pipe 13, each injector 14 to 17, the intermediate-pressure relief valve 18, the low-pressure relief valve 19, the secondary pressure sensor 32, the tertiary pressure sensor 33, and pipes 20 connecting these components are integrally configured as a single unit.

On a cathode side of the fuel cell 1, in contrast, there are provided an air supply passage 21 for supplying air to the fuel cell 1, and an air discharge passage 22 for discharging out air offgas to be delivered out of the fuel cell 1. In the air supply passage 21, an air pump 23 is provided to regulate a flow rate of air to be supplied to the fuel cell 1. In the air supply passage 21 downstream of the air pump 23, an air pressure sensor 34 is provided to detect air pressure P4. In the air discharge passage 22, a second changeover valve 24 constituted of an electromagnetic valve is provided.

In the above structure, the hydrogen gas delivered out of the hydrogen cylinder 2 will be supplied to the fuel cell 1 by passing through the hydrogen supply passage 3 via the main stop valve 5, the high-pressure regulator 7, and the hydrogen flow regulating device 12. The hydrogen gas supplied to the fuel cell 1 is used for power generation in this cell 1 and then discharged as hydrogen offgas from the cell 1 through the hydrogen discharge passage 4 and the first changeover valve 6.

In the above configuration, the air discharged from the air pump 23 to the air supply passage 21 will be supplied to the fuel cell 1. The air supplied to the fuel cell 1 is used for power generation in the cell 1 and then discharged as air offgas from the cell 1 through the air discharge passage 22 and the second changeover valve 24.

The above fuel cell system further includes a controller 40 operative to control the system. The controller 40 is configured to control the main stop valve 5 and each of the injectors 14 to 17 based on detection values of the primary pressure sensor 31, the secondary pressure sensor 32, and the tertiary pressure sensor 33 in order to control a flow of the hydrogen gas to be supplied to the fuel cell 1. Further, the controller 40 is also configured to control the first changeover valve 6 in order to control a flow of hydrogen offgas in the hydrogen discharge passage 4. The controller 40 is also arranged to control the air pump 23 based on a detection value of the air pressure sensor 34 in order to control a flow of air to be supplied to the fuel cell 1. Further, the controller 40 is configured to control the second changeover valve 24 in order to control a flow of air offgas in the air discharge passage 22. The controller 40 is further configured to receive each of a voltage value and a current value related to power generation in the fuel cell 1. The controller 40 includes a central processing unit (CPU) and a memory and is configured to control each of the injectors 14 to 17, the air pump 23, and others based on a predetermined control program stored in the memory in order to control a hydrogen gas amount and an air amount to be supplied to the fuel cell 1.

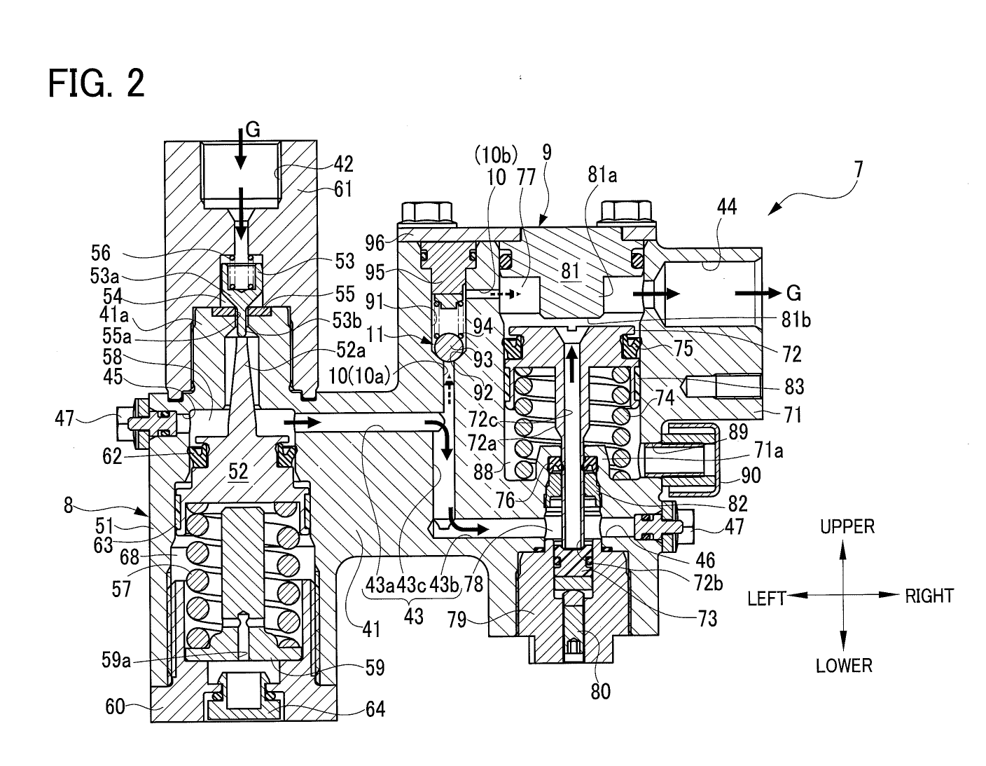

Herein, the details of the high-pressure regulator 7 will be explained. FIG. 2 is a schematic sectional view of the high-pressure regulator 7. In FIG. 2, an alphabet “G” and thick arrows and broken arrows represent hydrogen gas and its flowing directions. This high-pressure regulator 7 is provided with a casing 41 made of aluminum alloy and, in this casing 41, integrally includes the first regulator 8, the second regulator 9, an inlet passage 42, an intermediate passage 43, an outlet passage 44, the communication passage 10, and the check valve 11. The inlet passage 42 is a passage in which hydrogen gas before being pressure-reduced by the first regulator 8 flows. The intermediate passage 43 is a passage in which the hydrogen gas after being pressure-reduced by the first regulator 8 but before being pressure-reduced by the second regulator 9 flows. The outlet passage 44 is a passage located downstream of the second regulator 9 and in which the hydrogen gas after being pressure-reduced by the second regulator 9 flows. The communication passage 10 allows communication between the intermediate passage 43 and a downstream part (a second pressure-regulating chamber 77 which will be mentioned later) of the second regulator 9.

In FIG. 2, in the casing 41, the first regulator 8 is placed on the left (upstream) side and the second regulator 9 is placed on the right (downstream) side, and the communication passage 10 and the internal air check valve 11 are arranged between the first regulator 8 and the second regulator 9. The check valve 11 is configured to open when the pressure of hydrogen gas in the intermediate passage 43 exceeds a predetermined valve opening pressure, so that the hydrogen gas is allowed to flow in a direction from the intermediate passage 43 toward the downstream part of the second regulator 9 through the communication passage 10 and the hydrogen gas is blocked from flowing in a reverse direction. Herein, the valve opening pressure of the check valve 11 is set to a set pressure (e.g., 6 (MPa)) obtained by adding a predetermined value (e.g., 1 (MPa)) to a maximum adjustment pressure (e.g., 5 (MPa)) of hydrogen gas in the intermediate passage 43. In the present embodiment, when the pressure of hydrogen gas in the intermediate passage 43 exceeds the foregoing set pressure, the communication passage 10 and the check valve 11 are operative to release hydrogen gas from the intermediate passage 43 to the downstream part of the second regulator 9 and further a side downstream from the second regulator 9.

The first regulator 8 includes a first cylinder 51 formed in the casing 41, a first piston 52 placed to be movable within the first cylinder 51, a rod 52a extending upward from the first piston 52, a first valve element 53 provided so as to be brought into contact with an upper end of the rod 52a, a first valve chamber 54 in which the first valve element 53 is accommodated, and a first valve seat 55 provided in the first valve chamber 54. In the first valve chamber 54, a valve-closing spring 56 having a coil shape is provided to urge the first valve element 53 in a direction to seat (valve closing) on the first valve seat 55. The inside of the first cylinder 51 is partitioned by the first piston 52 into a first pressure-regulating chamber 58 and a first atmospheric chamber 68. Specifically, in the first cylinder 51, over of the first piston 52, the first pressure-regulating chamber 58 is provided to regulate the pressure of hydrogen gas. In the first atmospheric chamber 68, a valve-opening spring 57 having a coil shape is provided to urge the first piston 52 and the rod 52a toward the first pressure-regulating chamber 58. More specifically, in the first atmospheric chamber 68, the valve-opening spring 57 is placed to urge the first valve element 53 through the first piston 52 and the rod 52a in a direction to separate (valve opening) the first valve element 53 from the first valve seat 55.

The inlet passage 42 communicates with the first valve chamber 54. The first valve element 53 has a needle-like shape and is arranged to be movable up and down in the first valve chamber 54. The first valve seat 55 is placed at a lower end of the first valve chamber 54. The first pressure-regulating chamber 58 is positioned below the first valve seat 55 and is brought into communication with the first valve chamber 54 when the first valve element 53 is moved to an open position. In the casing 41 there are provided a spring holder 59 placed in contact with a lower end of the valve-opening spring 57 to receive this spring 57, and a stopper member 60 threadedly engaged in the casing 41 to retain the spring holder 59 at an adjustable height.

For the first regulator 8, the casing 41 is formed with a cylindrical protruding part 41a protruding upward. The first valve seat 55 is provided at an upper end of this protruding part 41a. The protruding part 41a is connected with a hexagonal joint block 61 threadedly engaged thereon from above. The inlet passage 42 and the first valve chamber 54 are formed in this joint block 61. The valve-closing spring 56 is provided between the joint block 61 and the first valve element 53. The first valve element 53 includes a tapered portion 53a having a tapered outer periphery and a needle portion 53b under the tapered portion 53a. The needle portion 53b is placed to penetrate through a valve hole 55a of the first valve seat 55. A lower end of the needle portion 53b contacts with the upper end of the rod 52a. Herein, the first valve chamber 54 and the inlet passage 42 are communicated with the first pressure-regulating chamber 58 through the valve hole 55a.

On an outer peripheral surface of the first piston 52, there is fitted an annular packing 62 to seal between the first piston 52 and the inner wall of the first cylinder 51. The packing 62 has a lip-shaped cross-section opening upward in a V shape. An upper end of the valve-opening spring 57 is retained on a lower surface of the first piston 52. On an outer periphery of a lower part of the first piston 52, a wear ring 63 made of fluorine contained resin is mounted. The holder member 59 contacting with the lower end of the valve-opening spring 57 is formed with a vent hole 59a. The stopper member 60 is provided with a filter member 64 for filtering the outside air to be drawn in through the vent hole 59a. The first atmospheric chamber 68 is communicated with atmosphere through the vent hole 59a and the filter member 64. The first pressure-regulating chamber 58 is connected to an upstream part (a second valve chamber 78) of the second regulator 9 through the intermediate passage 43.

Accordingly, the first regulator 8 is driven by the balance between the pressure of hydrogen gas supplied to the inlet passage 42, the pressure of hydrogen gas in the first pressure-regulating chamber 58, the urging force of the valve-closing spring 56, and the urging force of the valve-opening spring 57, and thereby reduces the pressure of hydrogen gas supplied to the inlet passage 42.

The second regulator 9 includes a second cylinder 71 formed in the casing 41, a second piston 72 placed to be movable within the second cylinder 71, a tubular second valve element 72a extending downward from the second piston 72, and a second valve seat 73 placed in correspondence with a lower end of the second valve element 72a. The inside of the second cylinder 71 is partitioned by the second piston 72 into a second pressure-regulating chamber 77 and a second atmospheric chamber 88. Specifically, in the second cylinder 71, over the second piston 72, the second pressure-regulating chamber 77 is provided to regulate the pressure of hydrogen gas. In the second atmospheric chamber 88, furthermore, a valve-opening spring 74 having a coil shape is provided to urge the second piston 72 and the second valve element 72a toward the second pressure-regulating chamber 77. More specifically, in the second atmospheric chamber 88, the valve-opening spring 74 is placed to urge the second valve element 72a through the second piston 72 in a direction to separate (valve opening) from the second valve seat 73. The second cylinder 71 is formed with a vent hole 89 in correspondence with the second atmospheric chamber 88. In this vent hole 89, a filter member 90 is fixed to filter the outside air. The second atmospheric chamber 88 is communicated with atmosphere through the vent hole 89 and the filter member 90. The second piston 72 is hollow and formed with a hollow section which is continuous with a hollow section 72c of the second valve element 72a. On the outer periphery of the second piston 72, an annular packing 75 having a lip-shaped cross-section is fitted to seal between the second piston 72 and the inner wall of the second cylinder 71. On the outer periphery of a lower part of the second piston 72, a wear ring 83 made of fluorine contained resin is mounted. In the second cylinder 71, over the second piston 72, the second pressure-regulating chamber 77 is provided to regulate the pressure of hydrogen gas. The second pressure-regulating chamber 77 corresponds to the downstream part of the second regulator 9.

In the second regulator 9, the outlet passage 44 is communicated with the second pressure-regulating chamber 77. Under the second cylinder 71, the second valve chamber 78 is provided in correspondence with the second valve element 72a and the second valve seat 73. Under the second valve chamber 78, a stopper member 79 is threadedly engaged in the casing 41. The second valve seat 73 is fitted in a recess formed at the top of the stopper member 79. This stopper member 79 is provided with an adjustment screw 80 to adjust the height (vertical position) of the second valve seat 73.

The second pressure-regulating chamber 77 is sealingly closed by a lid member 81 fitted in the casing 41 from above. The lid member 81 is formed, at its bottom, with a protrusion 81a with which an upper end of the second piston 72 can come into contact. A lower end face of this protrusion 81a serves as a stopper part 81b to restrict upward movement of the second piston 72, that is, to restrict a movable range of the second piston 72. When the upper end of the second piston 72 comes into contact with the stopper part 81b, an annular space is generated in the second pressure-regulating chamber 77. The second pressure-regulating chamber 77 is always communicated with the outlet passage 44.

The hollow section 72c formed throughout the second piston 72 and the second valve element 72a has openings at both ends in an axial direction. An upper end of the valve-opening spring 74 is retained on a lower surface of the second piston 72. A lower end of the valve-opening spring 74 is retained on the bottom of the second cylinder 71 at a position surrounding a protrusion 71a formed on the bottom.

Inside this protrusion 71a, there is provided an annular packing 76 having a lip-shaped cross-section placed in slidable contact with the outer periphery of the second valve element 72a to seal the second valve chamber 78. Under the packing 76, a bearing 82 is provided in slidable contact with the second valve element 72a to support this second valve element 72a. The bearing 82 also serves as a stopper to prevent the packing 76 from dropping off. The second valve chamber 78 is formed in a nearly cylindrical shape under the bearing 82 and is communicated with the intermediate passage 43.

The intermediate passage 43 includes a first intermediate passage 43a horizontally extending from the first pressure-regulating chamber 58 of the first regulator 8, a second intermediate passage 43b horizontally extending from the second valve chamber 78 of the second regulator 9, and a third intermediate passage 43c vertically extending and connecting between the first intermediate passage 43a and the second intermediate passage 43b. The casing 41 is formed with a working hole 45 formed at the time of making the first intermediate passage 43a, and a working hole 46 formed at the time of making the second intermediate passage 43b. The casing 41 is further provided with plugs 47 individually sealing the working holes 45 and 46. An upper end of the third intermediate passage 43c is connected to the communication passage 10.

Accordingly, the second regulator 9 is driven by the balance between the pressure of hydrogen gas in the intermediate passage 43 acting on the second valve chamber 78 (the pressure of hydrogen gas after being pressure-reduced by the first regulator 8), the pressure of hydrogen gas in the outlet passage 44 acting on the second pressure-regulating chamber 77, and the urging force of the valve-opening spring 74, and thereby further reduces the pressure of hydrogen gas in the intermediate passage 43.

The check valve 11 is provided with a valve chamber 91, a valve seat 92 formed at an entrance of the valve chamber 91, a ball-shaped valve element 93 accommodated in the valve chamber 91 so as to be brought into contact with or separated from the valve seat 92, a valve-closing spring 94 having a coil shape and urging the valve element 93 toward the valve seat 92 in a valve-closing direction, a plug 95 holding the valve-closing spring 94 and sealing the valve chamber 91, and a retaining plate 96 for preventing the plug 95 and the lid member 81 from dropping out of the casing 41. Herein, the valve chamber 91 is communicated with the second pressure-regulating chamber 77 through a downstream communication passage 10b. The downstream communication passage 10b is formed coaxial with the outlet passage 44.

Accordingly, this check valve 11 opens when the pressure of hydrogen gas in the intermediate passage 43 becomes higher than a predetermined valve opening pressure to allow the hydrogen gas to flow from the intermediate passage 43 toward the second pressure-regulating chamber 77 of the second regulator 9 through the communication passage 10, but the check valve 11 blocks a flow of hydrogen gas in an opposite direction. In the present embodiment, the valve opening pressure of the check valve 11 is set larger than a pressure value calculated by adding a predetermined value to a normal adjustment pressure of hydrogen gas in the intermediate passage 43. Specifically, the communication passage 10 and the check valve 11 are configured to permit the hydrogen gas to escape to the outlet passage 44 through the second pressure-regulating chamber 77 of the second regulator 9 only when the pressure of hydrogen gas in the intermediate passage 43 becomes excessive.

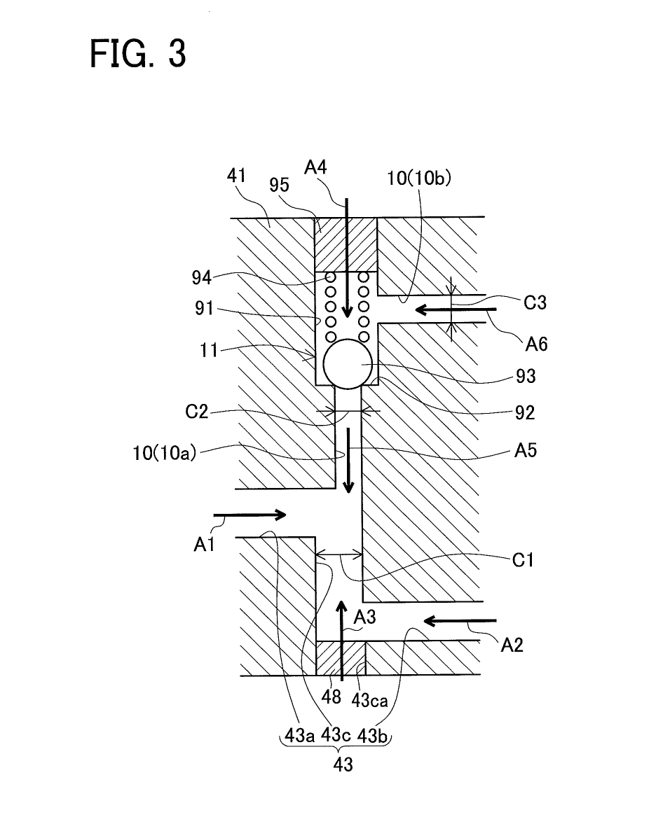

FIG. 3 is a schematic sectional view showing the intermediate passage 43, the communication passage 10, and check valve 11 in the high-pressure regulator 7. As shown in FIGS. 2 and 3, the communication passage 10 includes an upstream communication passage 10a vertically extending to communicate with the third intermediate passage 43c and a downstream communication passage 10b horizontally extending to connect an upper part of the upstream communication passage 10a and the second pressure-regulating chamber 77 of the second regulator 9. The upstream communication passage 10a corresponds to a part of the communication passage 10 located upstream of the check valve 11. The downstream communication passage 10b corresponds to a part of the communication passage 10 located downstream of the check valve 11. In the present embodiment, the entire region of the intermediate passage 43, that is, all of the first intermediate passage 43a, the second intermediate passage 43b, and the third intermediate passage 43c, is formed with the same inner diameter by a drill or the like. Further, a first passage cross-sectional area C1 of the intermediate passage 43 (the first intermediate passage 43a, second intermediate passage 43b, and third intermediate passage 43c) is set to a passage cross-sectional area for providing a maximum flow rate when the primary-side pressure of hydrogen gas in the inlet passage 42 is a smallest set value (e.g., 2.1 (MPa)) of the present hydrogen supply system. In the present embodiment, as shown in FIG. 3, the entire region of the communication passage 10 excepting the check valve 11, that is, both the upstream communication passage 10a and the downstream communication passage 10b, is formed with the same inner diameter by a drill or the like. A second passage cross-sectional area C2 and a third passage cross-sectional area C3 of the communication passage 10 (the upstream communication passage 10a and the downstream communication passage 10b) are set smaller than the first passage cross-sectional area C1 of the intermediate passage 43. Moreover, the second passage cross-sectional area C2 of the upstream communication passage 10a and the third passage cross-sectional area C3 of the downstream communication passage 10b are each set to a predetermined passage cross-sectional area adequate to prevent the pressure of hydrogen gas in the intermediate passage 43 from exceeding the set value obtained by adding a predetermined value to the normal adjustment pressure.

Referring to FIG. 3, a method for making the intermediate passage 43, the valve chamber 91, and the communication passage 10 will be described below. The intermediate passage 43, the valve chamber 91, and the communication passage 10 are each formed in the casing 41 by a drill or the like after production of the casing 41. To be concrete, the intermediate passage 43 is made by machining the casing 41 by a drill or the like in three directions indicated by thick arrows A1, A2, and A3. At that time, the drill used for machining in the directions of the arrows A1 to A3 has the same diameter. Herein, when the casing 41 is machined with the drill or the like in the direction of the arrow A3 to form the third intermediate passage 43c, an opening 43ca is formed in the casing 41 due to the drill or the like. Thus, this opening 43ca is thereafter blocked off with a plug 48 (not shown in FIG. 2). The casing 41 is further machined by a drill or the like in the direction of an arrow A4 to form the valve chamber 91. The drill or the like used at that time has a larger diameter than that of the drill or the like used to form the intermediate passage 43. Successively, the casing 41 is machined by a drill or the like in the direction indicated by an arrow A5 to form the upstream communication passage 10a. The drill or the like used at that time has a smaller diameter than that of the drill or the like used to form the intermediate passage 43. Thereafter, the casing 41 is further machined by a drill or the like in the direction indicated by an arrow A6 to form the downstream communication passage 10b. The drill or the like used at that time has the same diameter as the drill or the like used to form the upstream communication passage 10a.

The high-pressure regulator 7 in the present embodiment described as above is operated in the following manner. In FIG. 1, when the main stop valve 5 is opened, hydrogen gas starts to be supplied from the hydrogen cylinder 2 to the fuel cell 1. Then, as shown in FIG. 2, in the high-pressure regulator 7, the hydrogen gas flows from the outlet passage 44 in a direction indicated with thick arrows, causing a decrease in the pressure of hydrogen gas in the second pressure-regulating chamber 77 of the second regulator 9. Thereby, the second piston 72 and the second valve element 72a are moved upward and thus the second valve element 72a separates from the second valve seat 73 to a valve open state. Accordingly, the hydrogen gas in the second valve chamber 78 is allowed to flow in the second pressure-regulating chamber 77 via the hollow section 72c of the second valve element 72a and the second piston 72, causing an increase in the pressure of hydrogen gas in the second pressure-regulating chamber 77. When the pressure of hydrogen gas in the second pressure-regulating chamber 77 reaches a predetermined pressure, the second piston 72 and the second valve element 72a are pressed downward against the urging force of the valve-opening spring 74, thereby bringing the lower end opening 72b of the second valve element 72a into contact with the second valve seat 73 to a valve closed state. This blocks the hydrogen gas from flowing from the second valve chamber 78 toward the second pressure-regulating chamber 77. It is to be noted that a screwing amount of the adjustment screw 80 can be adjusted in advance to set the pressure of hydrogen gas in the second pressure-regulating chamber 77 to a predetermined final pressure.

The second valve chamber 78 of the second regulator 9 and the first pressure-regulating chamber 58 of the first regulator 8 are communicated with each other through the intermediate passage 43. Thus, when the pressure of hydrogen gas in the second valve chamber 78 lowers, the hydrogen gas in the first pressure-regulating chamber 58 flows into the second valve chamber 78 through the intermediate passage 43 and hence the pressure of hydrogen gas in this valve chamber 78 rises. Accordingly, in the first regulator 8, the pressure of hydrogen gas in the first pressure-regulating chamber 58 lowers and thus the first piston 52 is moved upward by the urging force of the valve-opening spring 57, thereby pressing the first valve element 53 upward, separating the first valve element 53 from the first valve seat 55 to a valve open state. This allows the high-pressure hydrogen gas supplied to the inlet passage 42 to flow in the first pressure-regulating chamber 58 through the first valve chamber 54, so that the pressure of hydrogen gas in the first pressure-regulating chamber 58 is kept at a predetermined intermediate pressure. It is to be noted that the screwing amount of the stopper member 60 can be adjusted in advance to set the pressure of the first pressure-regulating chamber 58 to the predetermined intermediate pressure.

Herein, when the main stop valve 5 is closed, supply of hydrogen gas from the hydrogen cylinder 2 to the fuel cell 1 is stopped, so that the pressure of hydrogen gas in the second pressure-regulating chamber 77 of the second regulator 9 stops decreasing. At that time, in the first regulator 8, foreign substances or the like may be trapped or caught between the first valve element 53 and the first valve seat 55, causing the first valve element 53 to be stuck as remaining open (valve opening failure) or causing the first valve element 53 to delay in closing (valve closing delay). In such a state, the high-pressure hydrogen gas in the inlet passage 42 leaks in the intermediate passage 43, but the hydrogen gas in the intermediate passage 43 is not allowed to escape therefrom, resulting in a sharp increase in the pressure of hydrogen gas in the intermediate passage 43.

Herein, even when the pressure of hydrogen gas in the intermediate passage 43 increases more than necessary, the check valve 11 is opened to allow the hydrogen gas to flow toward the second pressure-regulating chamber 77 of the second regulator 9 through the communication passage 10 and further flow toward the side downstream from the second regulator 9. Thus, the hydrogen gas in the intermediate passage 43 is pressure-reduced. Since the second passage cross-sectional area C2 and the third passage cross-sectional area C3 of the communication passage 10 are set smaller than the first passage cross-sectional area C1 of the intermediate passage 43, even when the pressure of hydrogen gas in the intermediate passage 43 becomes excessive, the pressure of hydrogen gas to be applied to the communication passage 10 is suppressed with respect to the excessive pressure of hydrogen gas, thereby reducing the pressure of hydrogen gas to be applied to the second pressure-regulating chamber 77 of the second regulator 9 and further to the downstream side from the second regulator 9. Specifically, the pressure of hydrogen gas lower than the excessive pressure of hydrogen gas acting on the intermediate passage 43 is applied to the second pressure-regulating chamber 77 of the second regulator 9 and the downstream side from the second regulator 9. Accordingly, even when the valve opening failure or the valve closing delay occurs in the first regulator 8, excessive pressure load is less likely to act on the downstream side from the second regulator 9 and thus it is unnecessary to provide any structure for ensuring pressure resistance of the downstream side. Herein, in the high-pressure regulator 7, the casing 41 itself has pressure resistance. Therefore the high-pressure regulator 7 does not need to be added with any structure for ensuring pressure resistance. Further, the hydrogen supply passage 3 connected to the outlet passage 44 of the high-pressure regulator 7 also does not need to be added with any separate structure as piping configuration to ensure pressure resistance.

In the present embodiment, the third passage cross-sectional area C3 of the downstream communication passage 10b located downstream of the check valve 11 is set smaller than the first passage cross-sectional area C1 of the intermediate passage 43. Accordingly, even when the check valve 11 is opened when the pressure of hydrogen gas in the intermediate passage 43 becomes excessive, the pressure of hydrogen gas to be applied to the downstream communication passage 10b is reduced and the pressure of hydrogen gas to be applied to the second pressure-regulating chamber 77 of the second regulator 9 and the downstream side from the second regulator 9 is also suppressed. Consequently, excessive pressure load is less likely to act on the downstream side from the second regulator 9 and it is therefore unnecessary to provide any additional structure for ensuring pressure resistance of the downstream side.

In the present embodiment, the second passage cross-sectional area C2 of the upstream communication passage 10a located upstream of the check valve 11 is set smaller than the first passage cross-sectional area C1 of the intermediate passage 43. Accordingly, even when the pressure of hydrogen gas in the intermediate passage 43 becomes excessive, the pressure of hydrogen gas to be applied to the upstream communication passage 10a is reduced and the pressure of hydrogen gas to be applied to the check valve 11 is also suppressed. Therefore, even when the pressure of hydrogen gas in the intermediate passage 43 rises beyond the valve opening pressure of the check valve 11, the check valve 11 is prevented from operating for valve opening. Specifically, an actual valve opening pressure of the check valve 11 becomes higher than the set valve opening pressure. This can increase the pressure at which the check valve 11 is opened to a higher value than the set valve opening pressure. Subsequently, even when the pressure of hydrogen gas in the intermediate passage 43 further becomes excessive to cause the check valve 11 to open, the pressure of hydrogen gas to be applied to the downstream communication passage 10b is reduced and also the pressure of hydrogen gas to be applied to the second pressure-regulating chamber 77 of the second regulator 9 and the downstream side from the second regulator 9 is suppressed. Thus, the excessive pressure load to be applied to the downstream side from the downstream communication passage 10b and subsequent sections can be suppressed in two stages and the need for a structure for ensuring pressure resistance of the downstream side can be eliminated.

In the present embodiment, the first passage cross-sectional area C1 of the intermediate passage 43 is set to a passage cross-sectional area enough to provide a maximum flow rate when the primary-side pressure of hydrogen gas with respect to the high-pressure regulator 7 becomes a smallest set value. Even when the primary-side pressure of hydrogen gas becomes the smallest set value, therefore, the hydrogen gas with the maximum flow rate is allowed to flow in the intermediate passage 43. This makes it possible to ensure a necessary flow rate of hydrogen gas to flow in the downstream side from the second regulator 9, that is, the downstream side from the high-pressure regulator 7.

In the present embodiment, the second passage cross-sectional area C2 and the third passage cross-sectional area C3 of the communication passage 10 are set to the passage cross-sectional areas adequate to prevent the pressure of hydrogen gas in the intermediate passage 43 from exceeding the set value obtained by adding the predetermined value to the normal adjustment pressure. Accordingly, the pressure of hydrogen gas flowing from the communication passage 10 and acting on the second pressure-regulating chamber 77 of the second regulator 9 and the downstream side from the second regulator 9 does not exceed the set value obtained by adding the predetermined value to the normal adjustment pressure in the intermediate passage 43. Even when the check valve 11 is opened, therefore, it is possible to prevent excessive pressure of hydrogen gas from being applied to the downstream side from the second regulator 9.

In the present embodiment, when the pressure of hydrogen gas in the intermediate passage 43 becomes excessive, this pressure acts on the check valve 11 through the communication passage 10, bringing the check valve 11 to the valve open state. Accordingly, the hydrogen gas in the intermediate passage 43 is released and escaped to the second pressure-regulating chamber 77 of the second regulator 9 through the communication passage 10 and the check valve 11. This can avoid any excessive pressure load deriving from the hydrogen gas from being applied to the packings 62 and 76 placed facing to or adjacent to the first pressure-regulating chamber 58 or the second valve chamber 78 each connected to the intermediate passage 43. Consequently, sealing failure or breakage of the packings 62 and 76 can be prevented. The hydrogen gas allowed to escape into the second pressure-regulating chamber 77 through the communication passage 10 and the check valve 11 then flows in the hydrogen supply passage 3 on the downstream side via the outlet passage 44. For this reason, the hydrogen gas is not released from the high-pressure regulator 7 to the outside of the hydrogen supply system, so that any wasteful consumption of hydrogen gas can be reduced.

Herein, the hydrogen gas stored in the hydrogen cylinder 2 may be filled under a pressure of the order of about 80 to 90 MPa according to filling facilities. In contrast, the pressure of hydrogen gas to be supplied from the high-pressure regulator 7 to each of the injectors 14 to 17 is reduced down to the order of 0.1 to 0.5 MPa. Accordingly, the high-pressure regulator 7 is configured such that for example the first regulator 8 reduces the pressure of hydrogen gas of the order of about 80 to 90 MPa to the order of about 3.0 to 2.5 MPa and the second regulator 9 reduces the pressure of hydrogen gas of the order of about 3.0 to 2.5 MPa to the order of about 0.1 to 1.5 MPa.

According to the present embodiment, even when opening failure of the first regulator 8 occurs due to trapped foreign substances or the like in the unitized high-pressure regulator 7, causing excessive pressure of hydrogen gas to act on the intermediate passage 43, the check valve 11 is opened to allow the pressure of hydrogen gas in the intermediate passage 43 to escape into the outlet passage 44 through the communication passage 10 and the second pressure-regulating chamber 77. Therefore, the check valve 11 can also function as a relief valve of the high-pressure regulator 7.

According to the present embodiment, the communication passage 10 and the check valve 11 are placed in a clearance space between the first regulator 8 and the second regulator 9. No special space needs to be added in the high-pressure regulator 7 configured as one unit. Thus, the dimension of the high-pressure regulator 7 including the first regulator 8 and the second regulator 9 can be prevented from increasing even when the communication passage 10 and the check valve 11 are provided.

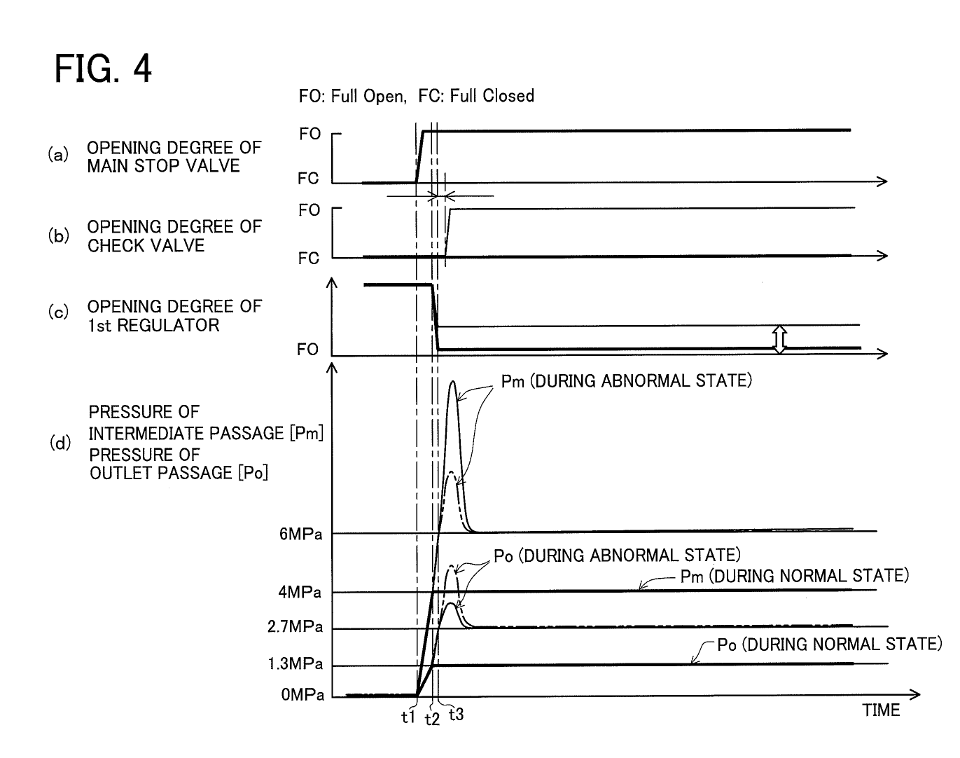

FIG. 4 is a time chart showing behaviors of (a) the opening degree of the main stop valve, (b) the opening degree of the check valve, (c) the opening degree of the first regulator, (d) the pressure [Pm] in the intermediate passage and the pressure [Po] in the outlet passage.

In FIG. 4(a) to (c), thick lines indicate each opening degree during a normal state and broken lines indicate each opening degree during an abnormal state. In FIG. 4(d), thick lines represent each pressure during the normal state and broken lines and two-dot chain lines represent each pressure during the abnormal state. In FIG. 4(d), further, the broken lines indicate the present embodiment and the two-dot chain lines indicate a conventional art.

When the main stop valve 5 is opened at time t1 to start supply of hydrogen gas from the hydrogen cylinder 2 to the hydrogen supply passage 3 as shown in FIG. 4(a), the first regulator 8 starts to be closed from a valve open state at time t2 as shown in FIG. 4(c).

Hereat, unless a valve opening failure occurs in the first regulator 8, as indicated by the thick lines in FIG. 4(b) to (d), the check valve 11 remains in a fully closed state and the first regulator 8 is closed to near a fully closed state, so that the pressure Pm in the intermediate passage 43 becomes constant at 4 MPa and the pressure Po in the outlet passage 44 becomes constant at 1.3 MPa.

When valve opening failure occurs in the first regulator 8 as indicated by the broken line in FIG. 4(c), in contrast, high-pressure hydrogen gas flows at a stroke into the intermediate passage 43 as indicated by the broken line in FIG. 4(d). Further, as indicated by the broken line in FIG. 4(b), when the check valve 11 delays in valve-closing, the pressure Pm in the intermediate passage 43 instantly rises (overshoots) to 6 MPa or higher. This pressure rise is larger than a pressure rise in the conventional art indicated by the two-dot chain line. In the present embodiment, however, the intermediate passage 43 is formed in the casing 41 made of metal, thus enabling easy achievement of resistance to such an instant pressure rise. The pressure Po in the outlet passage 44 at that time in the present embodiment indicated by the broken line in FIG. 4(d) is lower than the pressure Po in the conventional art indicated by the two-dot chain line. Specifically, since the second passage cross-sectional area C2 and the third passage cross-sectional area C3 of the communication passage 10 are set smaller than the first passage cross-sectional area C1 of the intermediate passage 43, it is possible to reduce the pressure of hydrogen gas to be applied to the downstream side from the second regulator 9. Consequently, pressure resistance of piping equipment downstream of the high-pressure regulator 7 can be reduced.

### Second Embodiment

Next, a second embodiment of the pressure-reducing apparatus of the invention embodied as a fuel cell system will be described below referring to the accompanying drawings.

In the following description, similar or identical components to those in the first embodiment are assigned the same reference signs and their details are not repeatedly described. The following description is therefore given with a focus on differences from the first embodiment.

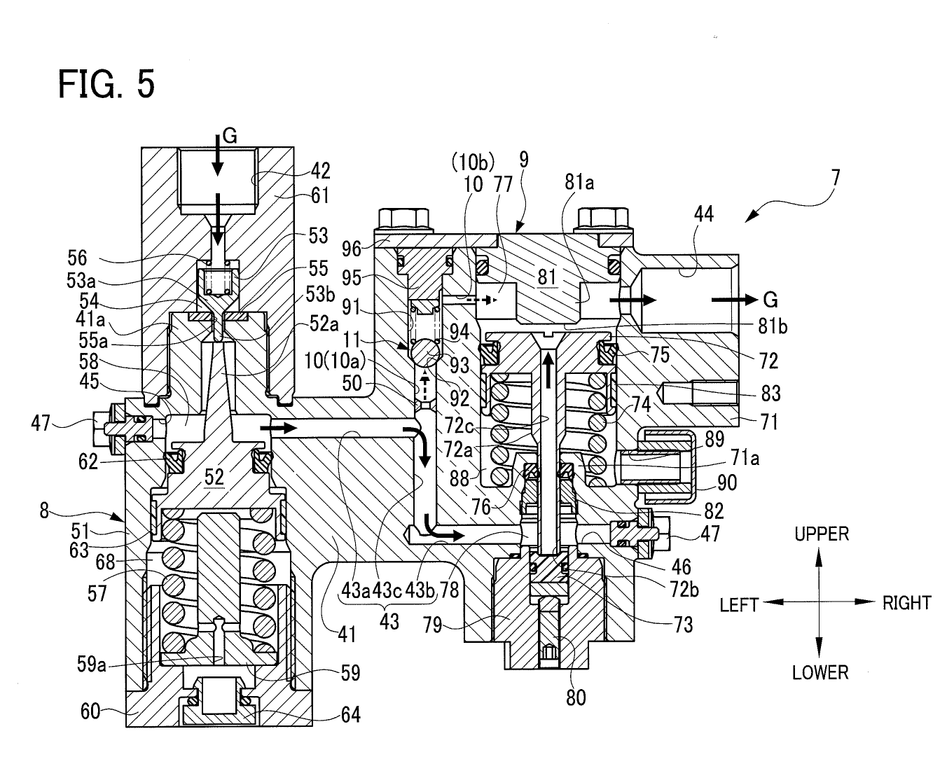

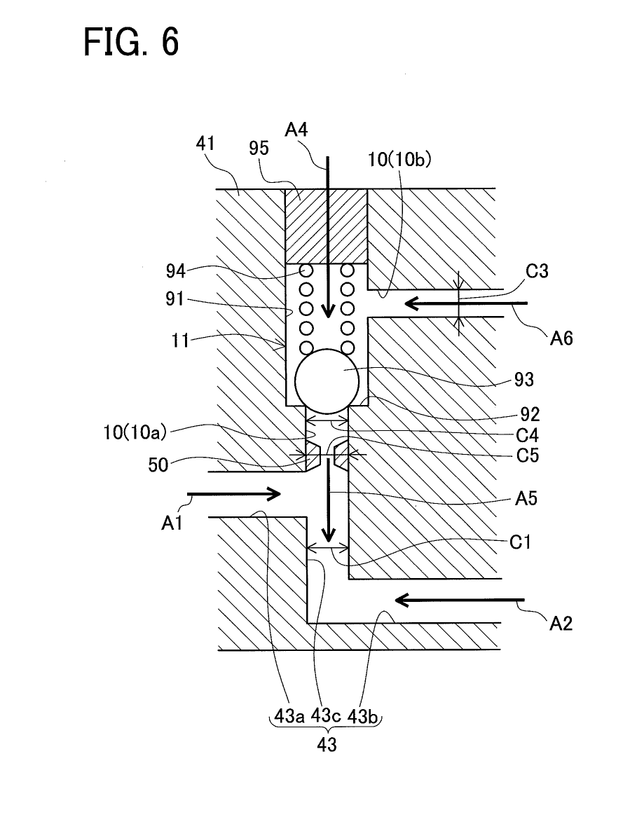

The high-pressure regulator 7 in the second embodiment differs in structure of the communication passage 10 from that in the first embodiment. FIG. 5 is a sectional view of the high-pressure regulator 7. FIG. 6 is a schematic sectional view showing the intermediate passage 43, the communication passage 10, and the check valve 11. In the present embodiment, as shown in FIG. 6, the entire region of the upstream communication passage 10a is configured with the same inner diameter as that of the intermediate passage 43. A fourth passage cross-sectional area C4 of the upstream communication passage 10a is set to be equal to the first passage cross-sectional area C1 of the intermediate passage 43. In addition, the upstream communication passage 10a is provided therein with a throttle member (a narrowing member) 50 to partially reduce the fourth passage cross-sectional area C4. The throttle member 50 is fixed by being press-fitted in the upstream communication passage 10a. Herein, a fifth passage cross-sectional area C5 of the throttle member 50 is set to equal to the third passage cross-sectional area C3 of the downstream communication passage 10b.

In the present embodiment, consequently, since the fourth passage cross-sectional area C4 of the upstream communication passage 10a is set to be equal to the first passage cross-sectional area C1 of the intermediate passage 43, the upstream communication passage 10a and the intermediate passage 43 (the third intermediate passage 43c) may be made together in one operation by the same drill or the like. Specifically, it is possible to eliminate the need to machine the casing 41 using the drill in a direction indicated with an arrow A3 as shown in FIG. 3. This can reduce the number of machining operations for making the upstream communication passage 10a. Since the machining operation shown in the arrow A3 can be made unnecessary, further, the hole 43ca can be unnecessary and the plug 48 can be omitted.

According to the present embodiment, the inner diameter of the valve seat 92 in the check valve 11 can be made larger than that in the first embodiment. This can enhance machining accuracy of the valve hole and thereby reducing variations in pressure adjustment of hydrogen gas by the check valve 11. Further, by simply providing the throttle member 50 without additionally separately machining the upstream communication passage 10a, the fifth passage cross-sectional area C5 of a part of the upstream communication passage 10a can be set smaller than the first passage cross-sectional area C1 of the intermediate passage 43. Consequently, there is no need to increase the kinds of tools such as a drill to make the passage cross-sectional area of the upstream communication passage 10a smaller than the first passage cross-sectional area C1 of the intermediate passage 43. In addition, the same operations and advantageous effects of the communication passage 10 as those in the first embodiment can be obtained. Other operations and advantageous effects are also the same as in the first embodiment.

### Third Embodiment

Next, a third embodiment of the pressure-reducing apparatus of the invention embodied as a fuel cell system will be described below referring to the accompanying drawings.

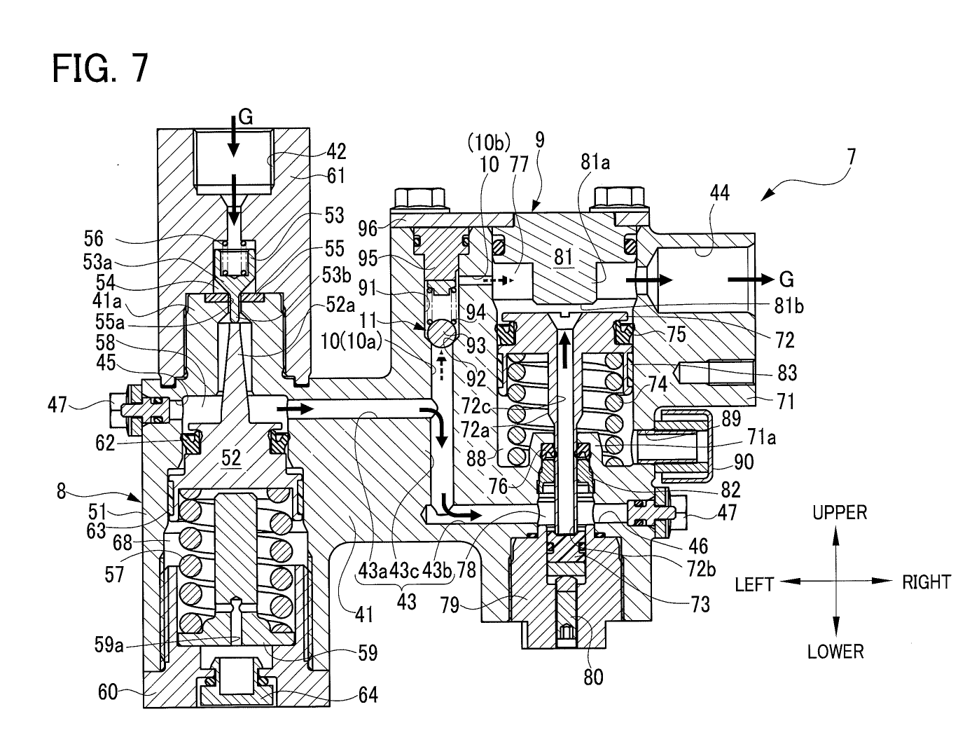

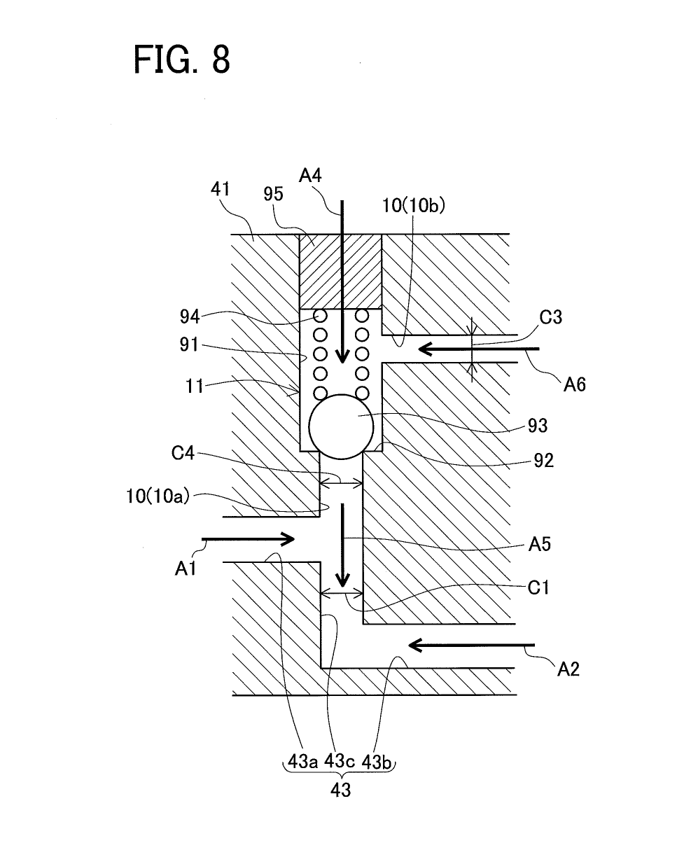

The high-pressure regulator 7 in the third embodiment differs in structure of the communication passage 10 from that in the second embodiment. FIG. 7 is a sectional view of the high-pressure regulator 7. FIG. 8 is a schematic sectional view showing the intermediate passage 43, the communication passage 10, and the check valve 11. The present embodiment differs from the second embodiment in that the throttle member 50 is omitted from the upstream communication passage 10a. In the present embodiment, specifically, the communication passage 10 is configured such that the fourth passage cross-sectional area C4 of the upstream communication passage 10a is set to equal to the first passage cross-sectional area C1 of the intermediate passage 43, and the third passage cross-sectional area C3 of the downstream communication passage 10b is set smaller than the first passage cross-sectional area C1 of the intermediate passage 43.

In the present embodiment, accordingly, even when the pressure of hydrogen gas in the intermediate passage 43 becomes excessive and directly acts on the check valve 11 through the upstream communication passage 10a, thereby causing the check valve 11 to open, the pressure of hydrogen gas to be applied to the downstream communication passage 10b is suppressed and also the pressure of hydrogen gas to be applied to the second pressure-regulating chamber 77 of the second regulator 9 and the downstream side from the second regulator 9 is suppressed. Further, it is possible to make the upstream communication passage 10a and the intermediate passage 43 together in one operation by the same drill or the like. This can reduce the number of machining operations for making the upstream communication passage 10a. Other operations and advantageous effects are also the same as in the first embodiment.

### Fourth Embodiment

Next, a fourth embodiment of the pressure-reducing apparatus of the invention embodied as a fuel cell system will be described below referring to the accompanying drawings.

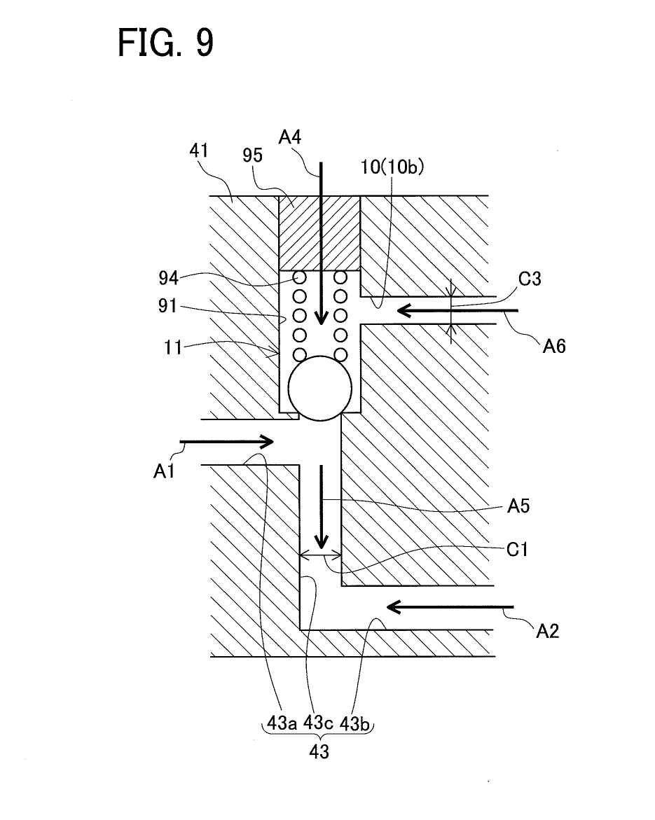

The high-pressure regulator 7 in the fourth embodiment differs in structure of the communication passage 10 from the third embodiment. FIG. 9 is a schematic sectional view showing the intermediate passage 43, the communication passage 10, and the check valve 11. The present embodiment differs from the third embodiment in that the upstream communication passage 10a is omitted from the communication passage 10. Specifically, the communication passage 10 is configured only of the downstream communication passage 10b. Accordingly, the check valve 11 is provided with an entrance directly opening in the intermediate passage 43.

Consequently, the present embodiment can also provide the same operations and advantageous effects as in the third embodiment. In addition, by virtue of the absence of the upstream communication passage 10a, manufacturing of the high-pressure regulator 7 can be simplified.

The present invention is not limited to each of the foregoing embodiments and may be modified or changed in other specific forms without departing from the essential characteristics thereof.

For instance, in the first embodiment, the entire region of the communication passage 10 (both the upstream communication passage 10a and the downstream communication passage 10b) is formed with the same inner diameter by a drill or the like so that the second passage cross-sectional area C2 and the third passage cross-sectional area C3 are set smaller than the first passage cross-sectional area C1 of the intermediate passage 43. As an alternative, it may be arranged that the entire region of the communication passage is formed with the same inner diameter by a drill or the like and further a throttle member is provided in each of the upstream communication passage and the downstream communication passage so that their passage cross-sectional areas are partly set smaller than the passage cross-sectional area of the intermediate passage.

In the second to fourth embodiments, the entire region of the downstream communication passage 10b is formed with the same inner diameter by a drill or the like so that the third passage cross-sectional area C3 is set smaller than the first passage cross-sectional area C1 of the intermediate passage 43. As an alternative, it may be arranged such that the entire region of the downstream communication passage is formed with the same inner diameter as the intermediate passage by a drill or the like and further a throttle member is provided in the downstream communication passage so that the passage cross-sectional area of the downstream communication passage is partly set smaller than the passage cross-sectional area of the intermediate passage.

In each of the foregoing embodiments, the pressure-reducing apparatus of the invention is embodied as the fuel cell system and utilized for the hydrogen supply system. As another embodiment, the pressure-reducing apparatus may be embodied as a fuel supply system of a bifuel engine system using gasoline and compression natural gas (CNG) or as a monofuel engine system using only CNG.

### INDUSTRIAL APPLICABILITY

The present invention is utilizable in systems using high-pressure fluid, such as a fuel cell system and a liquefied natural gas system.

### REFERENCE SIGNS LIST

7 High-pressure regulator (Pressure-reducing apparatus)
8 First regulator (First pressure-reducing valve)
9 Second regulator (Second pressure-reducing valve)
10 Communication passage
10a Upstream communication passage
10b Downstream communication passage
11 Check valve
43 Intermediate passage
43a First intermediate passage
43b Second intermediate passage
43c Third intermediate passage
77 Second pressure-regulating chamber (Downstream part)
C1 Passage cross-sectional area of intermediate passage
C2 Passage cross-sectional area of upstream communication passage
C3 Passage cross-sectional area of downstream communication passage
C4 Passage cross-sectional area of upstream communication passage
C5 Passage cross-sectional area of throttle member

What is claimed is:

1. A pressure-reducing apparatus including two pressure-reducing valves arranged in series, the pressure-reducing apparatus being configured to reduce and regulate primary-side pressure of fluid in two stages by use of the two pressure-reducing valves to generate secondary-side pressure of the fluid, wherein
the two pressure-reducing valves include a first pressure-reducing valve placed on an upstream side and a second pressure-reducing valve placed on a downstream side;
the pressure-reducing apparatus further includes:
an intermediate passage in which the fluid after being pressure-reduced by the first pressure-reducing valve but before being pressure-reduced by the second pressure-reducing valve;
a communication passage allowing communication between the intermediate passage and a downstream part in the second pressure-reducing valve; and
a check valve provided in the communication passage and configured to open when pressure of the fluid in the intermediate passage becomes higher than a predetermined valve opening pressure to allow the fluid to flow from the intermediate passage toward the downstream part in the second pressure-reducing valve through the communication passage, and configured to inhibit the fluid from flowing in an opposite direction, and
the communication passage has at least a part having a passage cross-sectional area set smaller than a passage cross-sectional area of the intermediate passage.

2. The pressure-reducing apparatus according to claim 1, wherein
the communication passage includes a downstream communication passage placed downstream of the check valve, and
the downstream communication passage has at least a part having a passage cross-sectional area set smaller than the passage cross-sectional area of the intermediate passage.

3. The pressure-reducing apparatus according to claim 2, wherein
the communication passage further includes an upstream communication passage located upstream of the check valve, and
the upstream communication passage has a passage cross-sectional area set equal to the passage cross-sectional area of the intermediate passage.

4. The pressure-reducing apparatus according to claim 3, wherein the upstream communication passage is provided with a throttle member configured to partially decrease the passage cross-sectional area of the upstream communication passage.

5. The pressure-reducing apparatus according to claim 2, wherein
the communication passage further includes an upstream communication passage placed upstream of the check valve, and
the upstream communication passage has at least a part having a passage cross-sectional area set smaller than the passage cross-sectional area of the intermediate passage.

6. The pressure-reducing apparatus according to claim 1, wherein the passage cross-sectional area of the intermediate passage is set to a passage cross-sectional area for providing a maximum flow rate when the primary-side pressure of the fluid is a smallest set value.

7. The pressure-reducing apparatus according to claim 1, wherein the passage cross-sectional area of the at least part of the communication passage is set to a predetermined passage cross-sectional area to prevent the fluid pressure in the intermediate passage from exceeding a set value obtained by adding a predetermined value to a normal regulation pressure.
